(19) United States
(12) Patent Application Publication
(10) Pub. No.: US 2006/0200734 A1
(43) Pub. Date: Sep. 7, 2006

(54) System for building and sharing a databank of jokes and/or such humor

(76) Inventor: Gautam Dharamdas Goradia, Maharashtra (IN)

Correspondence Address: INTELLECTUAL PROPERTY LAW GROUP LLP, 12 SOUTH FIRST STREET, SUITE 1205, SAN JOSE, CA, 95113, US

(21) Appl. No.: 10/538,679

(22) PCT Filed:
(86) PCT No.: PCT/IN03/00300

(30) Foreign Application Priority Data
May 14, 2003 (IN) 488/MUM/2003

(51) Int. Cl. G06F 17/00

(52) U.S. Cl. 715/500

(57) ABSTRACT

Disclosed is a system for building a data bank (data base) of jokes and/or such humor for enjoyment/entertainment purposes, as well as for as part of ones' social life, and/or for stress reduction purposes. The present system comprises a computer, one or more databases for user interaction, a well classified user database, and at least one user controlled management module capable of voice. The present system additionally comprises invoking as laughter session, scheduling jokes and/or humor at predefined or periodic intervals, exporting and importing of data, as well as a translation module.

### FIELD OF INVENTION

The present invention relates to a system for building and sharing a databank of jokes and/or such humor for use in daily life, it being accepted that Jokes and/or such Humor are part of a person's social life, and/or using such Jokes and/or such Humor serve as a tool to relieve general stress, it being accepted that laughter in general assists in stress relief, which would help in the overall improvement of the health of a person.

### BACKGROUND OF THE INVENTION

It is a well-accepted fact that Jokes and/or such Humor are part of one's daily life and people like to use Jokes and/or such Humor in their daily lives.

It is a well-accepted fact that laughter in general helps in stress relief, with the result that there are several laughter clubs in society.

Because Jokes and/or such Humor are popular with one and all, there is a lot of literature written on such topics and several dramas, films and television programs are based on Humor.

It is a well accepted fact that people generally cannot remember a large amount of data whether by classifications or not, without external help, and it would be very helpful if there were to exist a system that would help people to add, retrieve, modify, delete, print, export, import, schedule such data based on Jokes and/or such Humor, thereby helping people to remember Jokes and/or such Humor for use in daily life for rejuvenating themselves from work fatigue.

U.S. Patent Application Publication No. US2003062683 discloses a traditional and ancient 52 “playing card” decks being inscribed with an equally traditional and ancient human recreation known as telling “jokes”.

German Patent Document DE10145898 discloses an invention that has a joke article, consisting of a container, which contains a loudspeaker as well as a micro controller and a one preferably out of microchip existing electronic memory. It also contains a playback unit containing laughter of humans stored in an electronic microchip, which produces noise of various forms. The container contains an image replication device, whereby the micro controller of a transmitter arranged outside of the container reads in and on a command signal from the memory again picks supplyable electrical video composite signals out over a wire-bound or wireless transmission circuit into the memory and supplies the image replication device. The container is also attached to Video Camera, which allows playing the movies when Jokes are played.

The Great Britain Patent Document GB2309393 discloses an apparatus that has a board, tokens, a set of cards with jokes printed on them, and a cassette of recorded laughter. In accordance with the rules of the game, players tell each other jokes from the cards and play the tape of recorded laughter, in order to induce the other players to laugh, whereupon the player(s) who laugh lose points.

From the above prior art, it will be understood that there exists a need for a system which would enable the user to create a data bank (data base) of Jokes and/or Humor and add, retrieve, modify, delete, print, export, import, schedule such data thereby enabling people to preserve and use Jokes and/or Humor for rejuvenating themselves from work fatigue in daily life.

### BRIEF SUMMARY OF THE INVENTION

An object of the present invention is to provide a system for building and sharing a data bank of Jokes and/or such Humor for use in daily life, wherein the system allows users to receive, find, build and store data of Jokes and/or such Humor, in a data base, by a well defined classification of data, such classification of data not restricted to any already provided data.

Yet another object of the present invention is to allow users to Customize the data by allowing the modification of the same, allowing the addition Bookmark Remarks, Associations, Files, including Media files, URLs and more Remarks to the same.

Yet another object of the present invention is to allow users to Navigate efficiently between the records.

Yet another object of the present invention is to allow users to Manipulate data Globally, and further selectively.

Yet another object of the present invention is to allow users to Share data created by the users using the Export/Import/Print modules, such Exporting/importing of data being capable of being Exported/Imported selectively.

Yet another object of the present invention is to provide users with the utility of Deleting the data, the scope of deleting data, being singular or plural, sending the deleted data to the Recycle Bin, and further deleting the same permanently, singularly or plurally, and/or restoring the same whether singularly or plurally.

Yet another object of the present invention is to allow users to invoke Laughter Session(s) using the stored Data and to use the records selected for the Laughter Session(s) as screen savers.

Yet another object of the present invention is to allow the User to Schedule the Jokes and/or such Humor by none or one or more classifications that the User may have used to create and/or modify such Jokes and/or such Humor, to be brought up on the User's computer screen including hand held devices at preset time intervals, with or without Voice.

Yet another object of the present invention is to provide various Reports selectively and having the further utility of customizing the same.

Yet another object of the present invention is to provide the necessary Tools to the User for better customization and maintenance of the system in various ways.

Yet another object of the present invention is to allow one or more module(s)/utility of the program to Operate within a browser and/or other viewing and/or processing programs, and which can operate on one or more computer systems including hand held devices.

Yet another object of the present invention is to provide a utility for creating, editing, deleting, printing, navigating, finding Masters like User, Age Group, Info Source, Type, Subject and Sub-Subjects, Language etc with sufficient security so as not to allow the deletion of any Master of a record that may be in use.

Yet another object of the present invention is to provide users with a Translation utility, allowing the User to consider any record as a parent language record and translate the same in any language of the User's choice, the translation activity happening from a translation module which is invoked in the data input module(s), and further that all of the features and/or utilities/functionality of the system remaining common to the translated record as would be applicable to the parent language record.

Yet another object of the present invention is to allow the User to input and/or modify data in the data input module(s) by Voice input, with or without a conjunction of input made by keyboard support, and/or to use any other utilities/functionality of the system, as may be supported by the system for such use, by Voice Command, and further to allow the User to receive Voice Output of the data so entered/modified by the User in the above data input module(s).

### BRIEF DESCRIPTION OF THE DRAWINGS

To complement the description that is being given and in order to promote a better understanding of the characteristics of the invention in accordance with a practical embodiment of the same and as an integral part of the said description a set of drawings accompany it in which, in an illustrative and non-restrictive way, the following are represented:—

FIG. 1 is the diagram of the System block of the present invention.

FIG. 2 is the diagram of the Multiple User system of the present invention

FIG. 3 is the diagram of the Outline of the System Process of the present invention

FIG. 4 is the diagram of the System Function for Jokes Bank Module of the present invention

FIG. 5 is the diagram of the System Operation for Jokes Bank Module of the present invention

FIG. 6 is the diagram of the System State Transition Diagram for Jokes Bank Module of the present invention

FIG. 7 is the diagram of the System Function for Global Association Module of the present invention

FIG. 8 is the diagram of the System Operation for Global Association Module of the present invention

FIG. 9 is the diagram of the System State Transition Diagram for Global Association module of the present invention

FIG. 10 is the diagram of the System Function for Global Attachment Module of the present invention

FIG. 11 is the diagram of the System Operation for Global Attachment Module of the present invention

FIG. 12 is the diagram of the System State Transition Diagram for Global Attachment Module of the present invention

FIG. 13 is the diagram of the System Function for Global Modification Module of the present invention

FIG. 14 is the diagram of the System Operation for Global Modification Module of the present invention

FIG. 15 is the diagram of the System State Transition Diagram for Global Modification Module of the present invention

FIG. 16 is the diagram of the System Function for Global Delete Module of the present invention

FIG. 17 is the diagram of the System Operation for Global Delete Module of the present invention

FIG. 18 is the diagram of the System State Transition Diagram for Global Delete Module of the present invention

FIG. 19 is the diagram of the System Function for Global Bookmark/Unbookmark Module of the present invention

FIG. 20 is the diagram of the System Operation for Global Bookmark/Unbookmark Module of the present invention

FIG. 21 is the diagram of the System State Transition Diagram for Global Bookmark/Unbookmark Module of the present invention

FIG. 22 is the diagram of the System Function for Export Module of the present invention

FIG. 23 is the diagram of the System Operation for Export Module of the present invention

FIG. 24 is the diagram of the System State Transition Diagram for Export Module of the present invention

FIG. 25 is the diagram of the System Function for Import Module of the present invention

FIG. 26 is the diagram of the System Operation for Import Module of the present invention

FIG. 27 is the diagram of the System State Transition Diagram for Import Module of the present invention

FIG. 28 is the diagram of the System Function for Laughter Session Module of the present invention

FIG. 29 is the diagram of the System Operation for Laughter Session Module of the present invention

FIG. 30 is the diagram of the System State Transition Diagram for Laughter Session Module of the present invention

FIG. 31 is the diagram of the System Function for Joke Scheduler Module of the present invention

FIG. 32 is the diagram of the System Operation for Joke Scheduler Module of the present invention

FIG. 33 is the diagram of the System State Transition Diagram for Joke Scheduler Module of the present invention

FIG. 34 is the diagram of the System Function for Recycle Bin Module of the present invention

FIG. 35 is the diagram of the System Operation for Recycle Bin Module of the present invention

FIG. 36 is the diagram of the System State Transition Diagram for Recycle Bin Module of the present invention

FIG. 37 is the diagram of the System Function for Tools/Help Menu Options of the present invention

FIG. 38 is the diagram of the System Operations for Tools/Help Menu Options of the present invention

FIG. 39 is the diagram of the System State Transition Diagram for Tools/Help Menu Options of the present invention

FIG. 40 is the diagram of the System Function for Translation Module of the present invention

FIG. 41 is the diagram of the System Operation for Translation Module of the present invention

FIG. 42 is the diagram of the System State Transition Diagram for Translation Module of the present invention

FIG. 43 is the diagram of the System Function for Global Translation Module of the present invention

FIG. 44 is the diagram of the System Operation for Global Translation Module of the present invention

FIG. 45 is the diagram of the System State Transition Diagram for Global Translation Module of the present invention

FIG. 46 is the diagram of the System Function for Master Module of the present invention

FIG. 47 is the diagram of the System Operation for Master Module of the present invention

FIG. 48 is the diagram of the System State Transition Diagram for Master Module of the present invention

### DETAILED DESCRIPTION OF THE PRESENT INVENTION

A detailed description of the preferred embodiments and best modes for practicing the present invention are described herein.

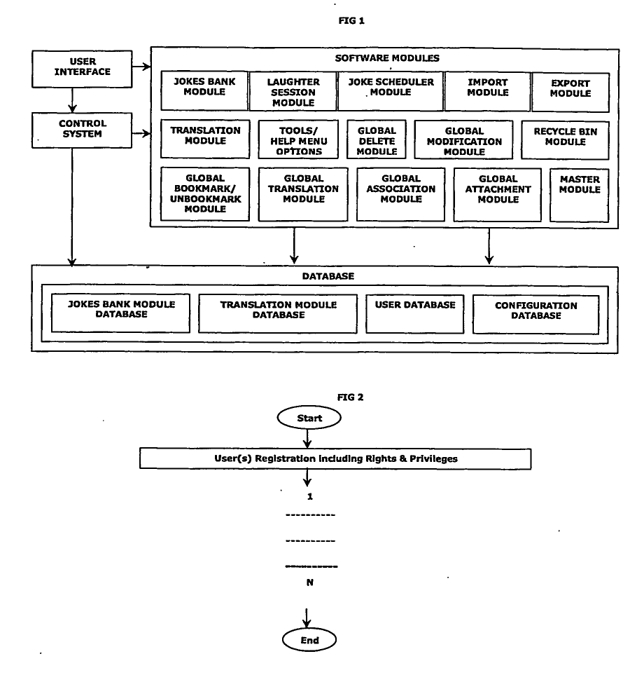

System for building and sharing a data bank of Jokes and/or such Humor, wherein FIG. 1 is the diagram of the different functional blocks and their interaction of the present invention. The User Interface renders the user's actions, and with the help of the Control System transmits the appropriate requests to the Database. The control system acts as the bridge between the User Interface and the Database.

The Database consists of Software Modules, Configuration Database, User Database and the Translation Module Database. The Software Modules are the reservoir of an extensible collection of the well-classified data. The

User Database is the reservoir of the user information and also contains the history of past user interaction with the system. The Configuration Database is the reservoir of the options used for the Customization of the Software. The Translation Database is the reservoir of the translated data.

If the user requests for the Jokes Bank Module through the user interface, then the control system asks the Database Management System to find the corresponding data from the Module, resulting in the display of the relevant data, if available. The user then interacts further with the Jokes Bank Module through the user interface.

If the user requests for the Laughter Session Module through the user interface, then the control system asks the Database Management System to find the corresponding data from the Module, resulting in the display of the relevant data, if available. The user then interacts further with the Laughter Session Module through the user interface.

If the user requests for the Joke Scheduler Module through the user interface, then the control system asks the Database Management System to find the corresponding data from the Module, resulting in the display of the relevant data, if available. The user then interacts further with the Joke Scheduler Module through the user interface.

If the user requests for the Import Module through the user interface, then the control system retrieves the corresponding data from a valid database file resulting in the display of the relevant data, if available. The user then interacts further with the Import Module through the user interface.

If the user requests for the Export Module through the user interface, then the control system finds the corresponding data resulting in the display of the relevant data, if available. The user then interacts further with the Export Module through the user interface.

If the user requests for the Translation Module through the user interface, then the control system finds the corresponding data resulting in the display of the relevant data, if available. The user then interacts further with the Translation Module through the user interface.

If the user requests for the Tools/Help Menu Options Module through the user interface, then the control system retrieves the corresponding Options available. The user then interacts further with the Tools/Help Menu Options through the user interface.

If the user requests for the Global Delete Module through the user interface, then the control system finds the corresponding data resulting in the display of the relevant data, if available. The user then interacts further with the Global Delete Module through the user interface.

If the user requests for the Global Modification Module through the user interface, then the control system finds the corresponding data resulting in the display of the relevant data, if available. The user then interacts further with the Global Modification Module through the user interface.

If the user requests for the Recycle Bin Module through the user interface, then the control system retrieves the corresponding data resulting in the display of the relevant data, if available. The user then interacts further with the Recycle Bin Module through the user interface.

If the user requests for the Global Bookmark/Unbookmark Module through the user interface, then the control system finds the corresponding data resulting in the display of the relevant data, if available. The user then interacts further with the Global Bookmark/Unbookmark Module through the user interface.

If the user requests for the Global Translation Module through the user interface, then the control system finds the corresponding data resulting in the display of the relevant data, if available. The user then interacts further with the Global Translation Module through the user interface.

If the user requests for the Global Association Module through the user interface, then the control system finds the corresponding data resulting in the display of the relevant data, if available. The user then interacts further with the Global Association Module through the user interface.

If the user requests for the Global Attachment Module through the user interface, then the control system finds the corresponding data resulting in the display of the relevant data, if available. The user then interacts further with the Global Attachment Module through the user interface.

If the user requests for the Master Module through the user interface, then the control system finds the corresponding data resulting in the display of the relevant data, if available. The user then interacts further with the Master Module through the user interface.

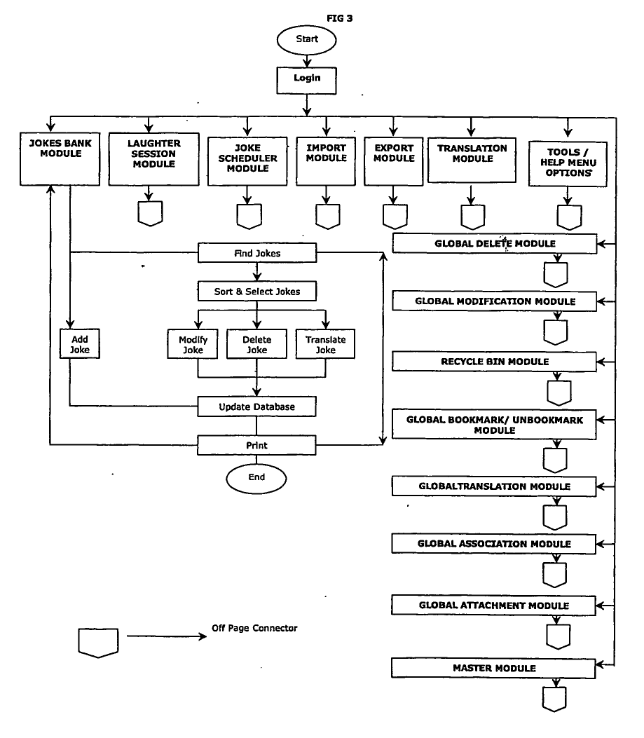

FIG. 2 is the diagram of the Multiple User system of the present invention. It explains that multiple users can use the system at the same time, and also explains that the system can be controlled by rights and privileges.

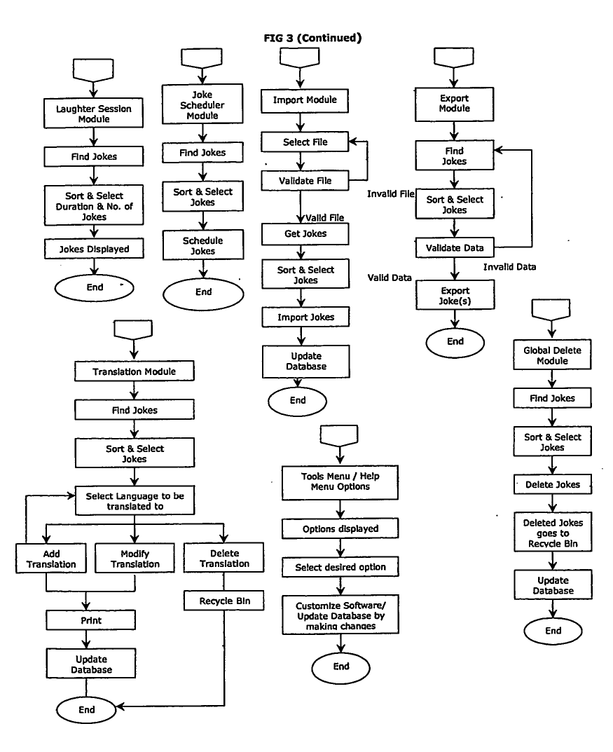

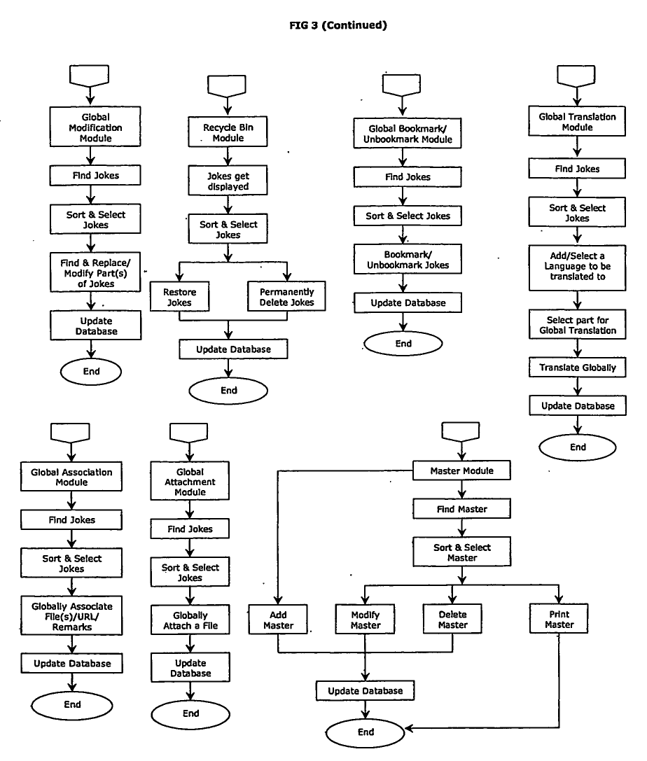

FIG. 3 is the diagram of the outline of the system process of the present invention. It exhibits the modules of the system and their main functions.

FIGS. 4 to 12 explain the system function, system operation, system state transition of the Jokes Bank, the system function, system operation, system state transition of the Global Association, the system function, system operation, system state transition of the Global Attachment, respectively of the present invention. The module(s) accept data (such data capable of being accepted from more than one user at the same time), with or without voice, from the user, by well defined classifications like (1) the Date of Entry, (2) Source of Information (to record the Source from where the User obtained the details the User is entering—EXAMPLE—The User may have read a Joke or such Humor in a particular book or magazine—say “XYZ” and would like to store this Source of Information), (3) Type (to record the Type of Joke or Humor the User is entering, e.g. Joke, Satire, Limerick etc.—EXAMPLE—the Joke or Humor may be in the form of a “KNOCK KNOCK JOKE” and the User may like to store the same under Type “KNOCK KNOCK JOKES”), Age Group (to record the relevant Age Group for which the Joke or Humor that the User is entering is meant for—EXAMPLE—the Joke or Humor may be meant for JUNIORS AGE GROUP or SENIORS AGE GROUP), (4) Subject (to record the Subject under which the Joke or Humor that the User is entering is to be stored—EXAMPLE—The Joke or Humor may be based on a profession, say the MEDICAL PROFESSION and the User may want to store the Joke or Humor under the SUBJECT MEDICAL JOKES), or which accept data created by another User (Exporting User) of the system by the above classifications, and which data may be further manipulated by the Importing User to suit the Importing User's requirements (EXAMPLE—the Exporting User may have classified a Joke or Humor as a MEDICAL JOKE, but the Importing User may like to classify the Joke or Humor as NURSE JOKES), and which is further used as part of the functions of the other modules of the system. (5) Sub Subject(s) (to record the Sub Subject (s) under which the details that the User is entering is to be stored—EXAMPLE—The Joke or Humor may be based on a profession, say the MEDICAL PROFESSION and the User may want to store the Joke or Humor under the SUBJECT MEDICAL JOKES and further classify the same up to 5 levels {Sub-Subjects} e.g. SUBJECT MEDICAL JOKES>SUB-SUBJECT1>HUMAN BODY>SUB-SUBJECT2>DISORDERS>SUB-SUBJECT3>HYPOCHONDRIA>SUB-SUBJECT4>PATIENT>SUB-SUBJECT5>FUNNY PATIENT

This module further allows the User to attach and or associate any kind of additional information like file(s), URLs and Remarks, file(s) and URLs being able to be opened by the system, the Remarks being simply displayed—EXAMPLE—The User may want to attach an IMAGE or an ANIMATION or a SOUND file to the record, or the User may also want to “associate” more information to the record by means of associating some information that may be on a file or a Web Site, and hence the User would associate a file or URL to the record. Such file(s) would be opened by the system. In case of a URL, the same would be opened by the system provided the User is connected to the Internet. The User may also simply wish to add a REMARK to the record. Such REMARKS are displayed to the User on demand using a browser.

The system also provides a utility to add specialized Remarks as “Bookmark Remarks”.

A further utility allows the user to send the record via SMS and/or MMS and/or Email and/or Network Messaging.

The user is allowed to input and/or modify data in any of the data input module(s) by Voice input, with or without a conjunction of input made by keyboard support, and/or use any other utilities/functionality of the system, as may be supported by the system for such use, by Voice Command, and further that the text to speech technology used enables the system to speak out the data so entered/modified by the User in the above data input module(s).

FIG. 4 is the diagram of the System Function for Jokes Bank Module of the present invention. The architecture of this module comprises the following major functions, which allow a user to create and store Jokes by well-defined classifications with the help of the User Interface.

The Jokes Bank Module through the User Interface causes the control system to find and retrieve the relevant data from the Jokes Bank Database/Translation Module Database. The module allows a user to:
Find existing Jokes
Sort & Select Jokes
Add & Save Jokes
Translate Jokes
Send Joke as SMS/MMS and/or Network Messaging and/or via Email
Modify & Save Jokes
Delete Jokes
Copy Current Entry
Print Current Joke/Jokes by different classifications
Go To a Joke
Bookmark/Unbookmark Joke
Attach/Associate File(s)/URL/Remarks to a Joke

FIG. 5 describes the System Operation of the Jokes Bank Module explaining that the Module is based on user actions, which are performed by loops. It allows user to create and store Jokes by well-defined classifications with the help of the User Interface.

The Add functionality allows the user to Input data in all the fields. The functionality is controlled through a top-level loop. The control system updates the Database and then the system waits for the next user action.

The Find functionality is controlled through a top-level loop wherein the user is asked to enter/select a find criterion, to bring forth Jokes based on the find criteria. After finding the Jokes, the user can sort the Jokes by different classifications and then can modify, delete or print the Jokes. After modification, if the user saves the Joke, the database gets updated and then the system waits for the next user action. Similarly, after deleting a Joke, the database gets updated and then the system waits for the next user action.

The Copy Current Entry functionality is controlled through a top-level loop. This functionality allows the user to copy the data existing in one or more of the current Joke and make the necessary additions/modifications in the other fields. The control system updates the new Joke in the Database and then the system waits for the next user action.

The Printing functionality is controlled through a top-level loop. The user can print the Joke facing the user, or can print Jokes that may have been found by a find criterion. The control system retrieves the Joke(s) from the Database and then the system waits for the next user action.

The Bookmark/Unbookmark Jokes functionality is controlled through a top-level loop. The user can Bookmark/Unbookmark the Joke facing the user, or can Bookmark/Unbookmark Jokes that may have been found by a find criterion. Bookmarking requires that the user add some remarks to the Bookmark. The control system updates the Database and then the system waits for the next user action. This functionality also allows the user to bookmark Jokes as Private or Public.

The Translation functionality is controlled through a top-level loop. The user can Translate the Joke facing the user, or can Translate Jokes that may have been found by a find criterion. Translation allows the user to consider any Joke as a parent language Joke and translate the same in any language of the User's choice. The control system updates the Database and then the system waits for the next user action.

The user can send Joke as SMS/MMS and/or Network Messaging and/or via Email the Joke facing the user, or can send Joke as SMS/MMS and/or Network Messaging and/or via Email Jokes that may have been found by a find criterion. The user finds the Joke by a find criterion and sends Joke as SMS/MMS and/or Network Messaging and/or via Email. The control system updates the Database and then the system waits for the next user action.

The user can Attach/Associate file (s) including Image, Animation or Sound Files/URL/Remarks the Joke facing the user, or can Attach/Associate file (s) including Image, Animation or Sound Files/URL/Remarks Jokes that may have been found by a find criterion. The Attach/Associate file (s) including Image, Animation or Sound Files/URL/Remarks functionality to a desired Joke is controlled through a top-level loop. The control system updates the Database and then the system waits for the next user action.

The Navigation functionality allows the user to navigate between Jokes.

On giving Close command the system gets notified and the user comes out from the module.

FIG. 6 describes the State Transition Diagram of the Jokes Bank Module explaining that the Module is based on the different States. The system receives events from the user(s), and each event causes the transition from one state to another within the module.

Each State contains its own separate Terminal State. A double lined transition arrow from State 4 indicates that multiple instances of the state are possible. So it is possible for multiple instances of state 4 to occur, each of which has its own terminal transition. A transition showed with a dotted line indicates that it is leaving from one State and entering another state.

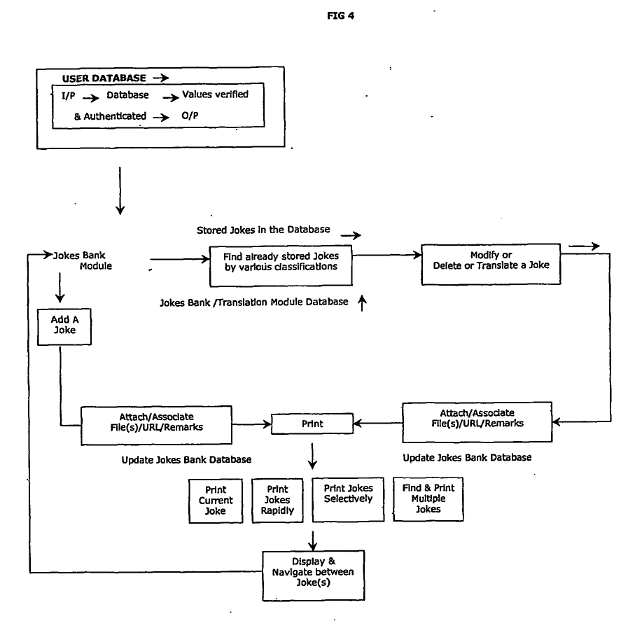

FIG. 7 is the diagram of the System Function for Global Association Module of the present invention. The architecture of this module comprises the following major functions, which allow a user to Associate File(s)/URL/Remarks to Jokes globally by finding the Jokes by various classifications with the help of the User Interface.

The Global Association Module through the User Interface causes the control system to find and retrieve the relevant data from the Jokes Bank/Translation Module Database. The module allows a user to:
Find existing Jokes
Sort & Select Jokes
Globally Associate File(s)/URL/Remarks

FIG. 8 describes the System Operation of Global Association Module explaining that the Module is based on the user actions, which are performed by loops. Through this Global Association Module, the user can Associate File(s)/URL/Remarks to Jokes globally by finding the Jokes by various classifications with the help of the User Interface.

Once the user finds the jokes by various classifications the user can sort & select those found Jokes and then the system waits for the next user action. Then the user can Associate File(s)/URLs/Remarks to Jokes globally through the User Interface. The system then waits for the next user action.

On giving Close command the system gets notified and the user comes out from the module.

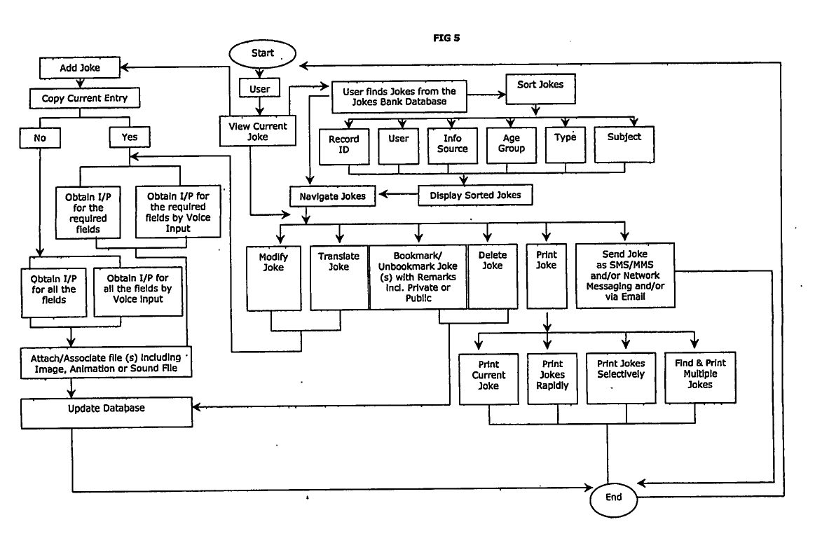

FIG. 9 describes the State Transition Diagram of the Global Association Module explaining that the Module is based on the different States. The system receives events from the user(s), and each event causes the transition from one state to another within the module.

Each State contains its own separate Terminal State. A double lined transition arrow from State 4 indicates that multiple instances of the state are possible. So it is possible for multiple instances of state 4 to occur, each of which has its own terminal transition. A transition showed with a dotted line indicates that it is leaving from one State and entering another state.

FIG. 10 is the diagram of the System Function for Global Attachment Module of the present invention. The architecture of this module comprises the following major functions, which allow a user to Attach a File to Jokes globally by finding the Jokes by various classifications with the help of the User Interface.

The Global Attachment Module through the User Interface causes the control system to retrieve the relevant data from the Jokes Bank/Translation Module Database. The module allows a user to:
Find existing Jokes
Sort & Select Jokes
Globally Attach a File

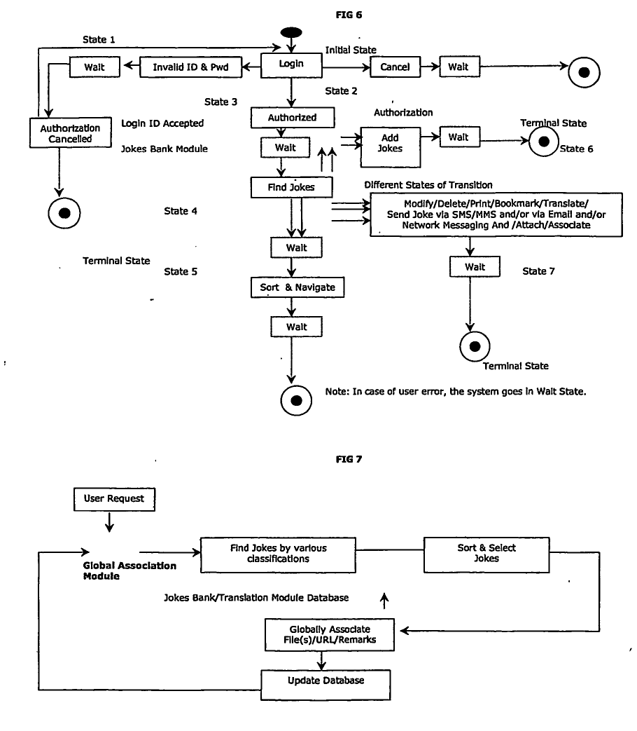

FIG. 11 describes the System Operation of Global Attachment Module explaining that the Module is based on the user actions, which are performed by loops. Through this Global Attachment Module, the user can Attach a File to Jokes globally by finding the Jokes by various classifications with the help of the User Interface.

Once the user finds the jokes by various classifications the user can sort & select those found Jokes and then the system waits for the next user action. Then the users can Attach a File to Jokes globally through the User Interface. The system then waits for the next user action.

On giving Close command the system gets notified and the user comes out from the module.

FIG. 12 describes the State Transition Diagram of the Global Attachment Module explaining that the Module is based on the different States. The system receives events from the user(s), and each event causes the transition from one state to another within the module.

Each State contains its own separate Terminal State. A double lined transition arrow from State 4 indicates that multiple instances of the state are possible. So it is possible for multiple instances of state 4 to occur, each of which has its own terminal transition. A transition showed with a dotted line indicates that it is leaving from one State and entering another state.

The system generates a new Record Id each time a new entry is made by a User or when a Record is imported by the User.

The system comprises of the utility, while creating a new data record, of copying an existing entry with respect to at least the above classifications under which the entry may have been stored, such “Copy Current Entry?” utility being of immense use to the User to simplify the creation of records having at least common classifications—EXAMPLE—If a User has an existing record classified as:

TYPE: LIMERICK

SUBJECT: LEGAL LIMERICKS

AGE GROUP: GENERAL

And the new record being entered by the User also happens to be falling under the above classifications, the “copy current entry” would make the new entry easier for the User, in that, the User would not have to reclassify the new entry.

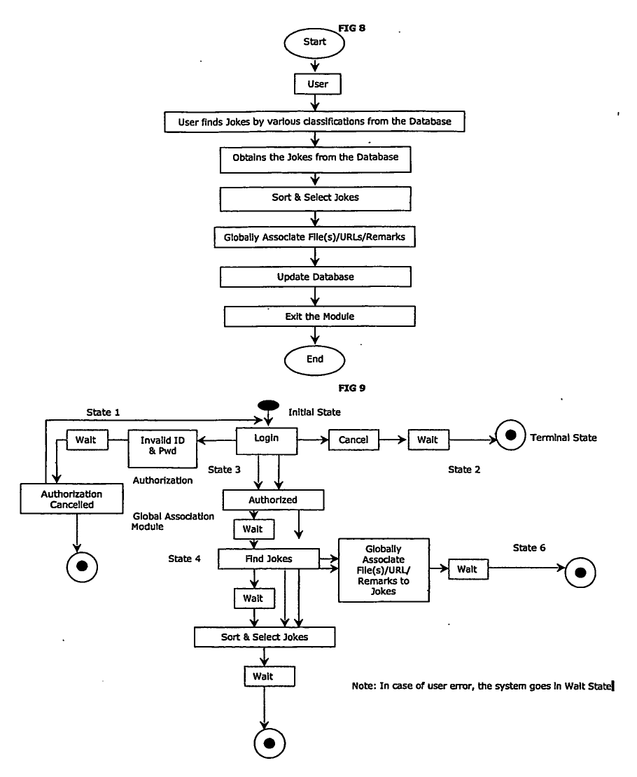

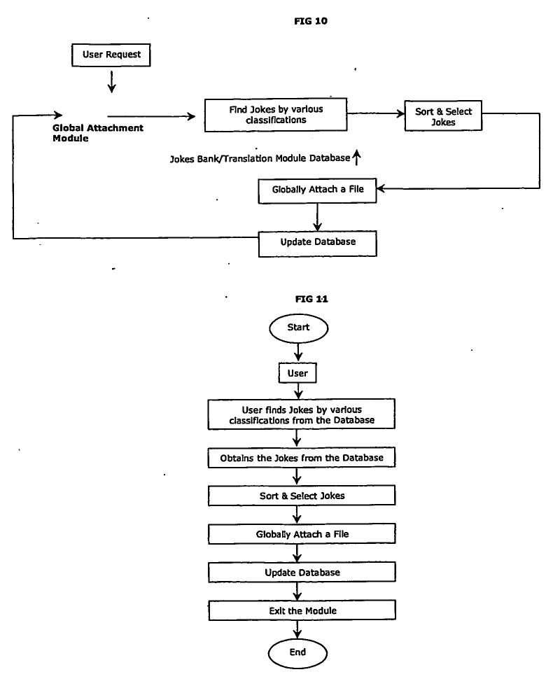

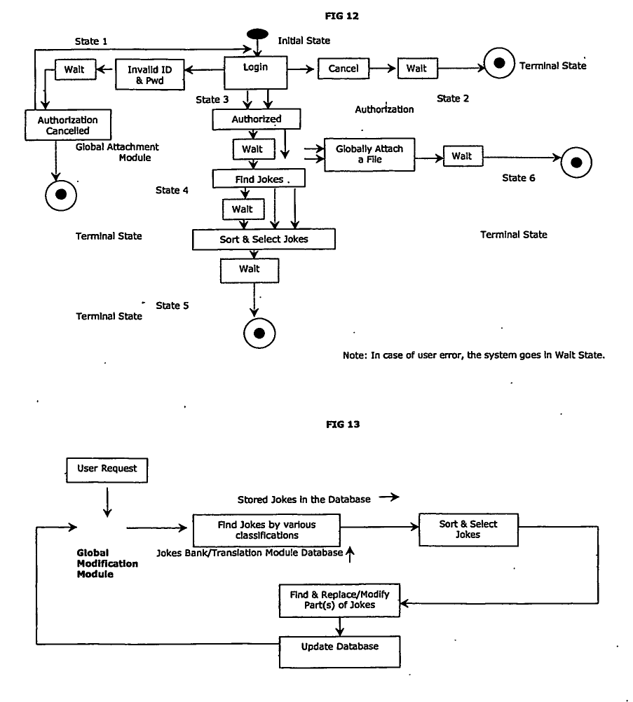

FIGS. 13 to 15 explain the system function, system operation and system state transition respectively of the utility of Modifying a record stored in the data input module(s)—EXAMPLE—The system allows the User to modify any part of an existing record by using the Edit utility. A record entered under the subject MEDICAL PROFESSION, being decided by the User to modify to be now stored under the subject NURSES, would be possible. This would hold true to any part of the record being wanted to be modified by the User, in that, any part or parts of the record is allowed to be modified by the User. There is a further utility of “Global Modification” where, Record(s) can be “found and replaced/modified” Globally. The records can be replaced/modified Globally by finding them based on none or one or more FIND conditions, the Results being displayed to the User in a grid format with a further utility to Sort the Results, Ascending or Descending, by some of the relevant classifications, and further allowing the User to select the records to be Globally replaced/modified from the result grid.—EXAMPLE—The User may want to change the subject of some or all Jokes having being classified under MEDICAL PROFESSION to the subject NURSES. The Global utility would permit the User to make this modification across multiple Jokes instead of modifying the same one by one.

FIG. 13 is the diagram of the System Function for Global Modification Module of the present invention. The architecture of this proposed module comprises the following major functions, which allow a user to Find & Modify/Replace part(s) of the Jokes globally, as desired, by finding the Jokes by various classifications with the help of the User Interface.

The Global Modification Module through the User Interface causes the control system to find and retrieve the relevant data from Jokes Bank/Translation Module Database. The module allows a user to:
Find existing Jokes
Sort & Select Jokes
Find & Replace/Modify part(s) of Jokes Globally

FIG. 14 describes Global Modification Module explaining that the Module is based on the user actions. This Module allows the user to Find & Replace/Modify part(s) of the Joke across several Jokes Globally as desired.

Once the user finds the jokes by various classifications the user can sort & select those found Jokes and then the system waits for the next user action. The control system retrieves those particular Jokes from the Database. Then the user modifies part(s) of (Find & Replace) those selected Jokes Globally through the User Interface. The system then waits for the next user action.

On giving Close command the system gets notified and the user comes out from the module.

FIG. 15 describes the State Transition Diagram of the Global Modification Module explaining that the Module is based on the different States. The system receives events from the user(s), and each event causes the transition from one state to another within the module.

Each State contains its own separate Terminal State. A double lined transition arrow from State 4 indicates that multiple instances of the state are possible. So it is possible for multiple instances of state 4 to occur, each of which has its own terminal transition. A transition showed with a dotted line indicates that it is leaving from one State and entering another state.

FIGS. 16 to 18 explain the system function, system operation and system state transition respectively of the utility of Deleting a record stored in the data input module(s), and having the further utility of “Global Delete” where the User can select the records to be Globally Deleted. The records can be deleted Globally by finding them based on none or one or more FIND conditions, the Results being displayed to the User in a grid format with a further utility to Sort the Results, Ascending or Descending, by some of the relevant classifications, and further allowing the User to select the records to be Globally Deleted from the result grid. Any record deleted is sent to the Recycle Bin of the system.

FIG. 16 is the diagram of the System Function for Global Delete Module of the present invention. The architecture of this module comprises the following major functions, which allow a user to delete Jokes globally by finding the Jokes by various classifications with the help of the User Interface.

The Global Delete Module through the User Interface causes the control system to find and retrieve relevant data from Jokes Bank/Translation Module Database. The module allows a user to:
Find existing Jokes
Sort & Select Jokes
Delete Jokes globally (which goes to Recycle Bin)

FIG. 17 describes Global Delete Module explaining that the Module is based on the user actions. Through this module the user can delete Jokes by finding the Jokes by various classifications with the help of the User Interface.

Once the user finds the jokes by various classifications the user can sort & select those found Jokes and then the system waits for the next user action. Then the user deletes those selected Jokes through the User Interface. The system then waits for the next user action.

On giving Close command the system gets notified and the user comes out from the module.

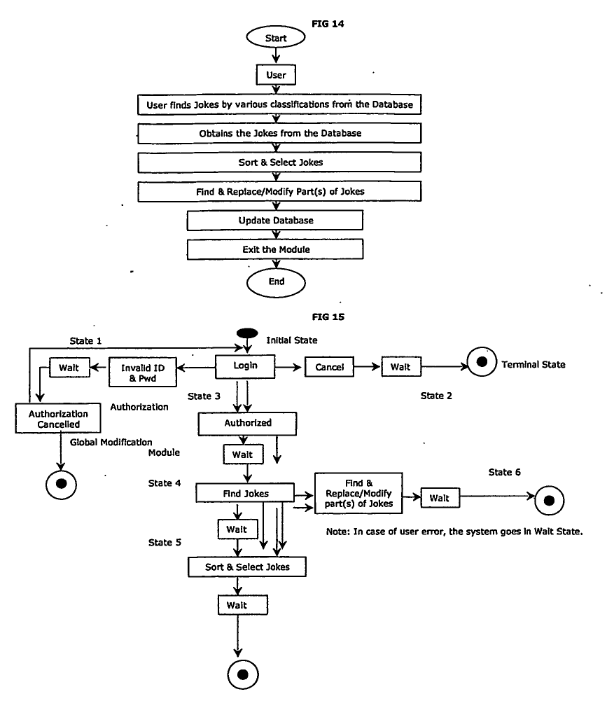

FIG. 18 describes the State Transition Diagram of the Global Delete Module explaining that the Module is based on the different States. The system receives events from the user(s), and each event causes the transition from one state to another within the module.

Each State contains its own separate Terminal State. A double lined transition arrow from State 4 indicates that multiple instances of the state are possible. So it is possible for multiple instances of state 4 to occur, each of which has its own terminal transition. A transition showed with a dotted line indicates that it is leaving from one State and entering another state.

The system comprises of the utility of Printing a record stored in the data input modules. The records can be printed by finding the same based on none or one or more FIND conditions, the Results being displayed to the User in a grid format with a further utility to Sort the Results, Ascending or Descending, by some of the relevant classifications, and further allowing the User to select the records to be printed from the result grid. The Printing utility offers further selections to be made by the User with respect to various print conditions such as printing a single record, or printing the results without further selections, or printing the results selectively, or printing the entire set of records available in the data bank (data base) with further selections if needed. The Printing utility further comprises of the Print reports to be Exported to various Destinations as various file formats.

The Printing utility provides the User the ability to customize the Header and Footer details.

The system comprises of the utility of Navigating between records in the data input module(s).

The system comprises of the utility of Finding records in the data input module(s), by none or one or more of the above classifications (and/or keywords including wildcards) that may have been used by the User to enter and/or modify the records, and also Finding records in the data input module(s), by the type of file attachments that may have been attached to the records, and/or Finding records in the data input module by the Bookmark Remarks added to the records, the Find Results being displayed to the User in a grid format with a further utility to Sort the Find Results, Ascending or Descending, by the relevant classifications that may have been used by the User to enter and/or modify the records in the data input module. Double clicking on any record will take the user to the concerned record.

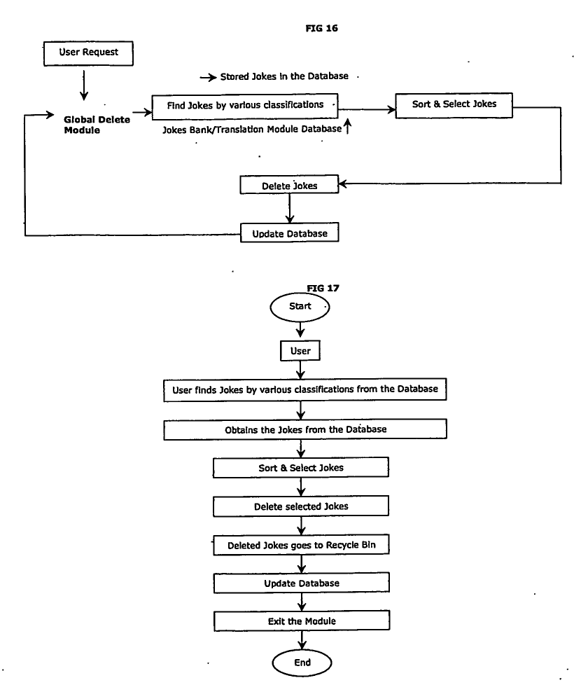

FIGS. 19 to 21 explain the system function, system operation and system state transition respectively of the utility of Book Marking or Unbook Marking one or more already Book Marked records in the data input module(s), and having the further utility of “Global Bookmark/Unbookmark” where the User can select the records to be Globally Bookmarked/Unbookmarked, and where the User can make further selections before actually Globally Bookmarking/Unbookmarking the records. The records can be Bookmarked/Unbookmarked, Globally in the data input module(s), by finding the same based on none or one or more FIND conditions, the Results being displayed to the User in a grid format with a further utility to Sort the Results, Ascending or Descending, by some of the relevant classifications, and further allowing the User to select the records to be Globally Bookmarked/Unbookmarked, from the result grid.

FIG. 19 is the diagram of the System Function for Global Bookmark/Unbookmark Module of the present invention. The architecture of this module comprises the following major functions, which allow a user to Bookmark/Unbookmark Jokes globally by finding the Jokes by various classifications with the help of the User Interface.

The Global Bookmark/Unbookmark Module through the User Interface causes the control system to find and retrieve the relevant data from Jokes Bank/Translation Module Database. The module allows a user to:
Find existing Jokes
Sort & Select Jokes
Global Bookmark/Unbookmark Jokes

FIG. 20 describes Global Bookmark/Unbookmark Module explaining that the Module is based on the user actions. This Module allows the user to Bookmark/Unbookmark Joke across several Jokes Globally as desired.

Once the user finds the Jokes by various classifications the user can sort & select those found Jokes and then the system waits for the next user action. The control system retrieves those particular Jokes from the Database. Then the user can Bookmark/Unbookmark those selected Jokes through the User Interface. To Bookmark a Joke, it is essential for the user to add Bookmark Remarks. The system then waits for the next user action. Any Bookmark Remarks added through this module would overwrite the Remarks added through the Jokes Bank Module.

On giving Close command the system gets notified and the user comes out from the module.

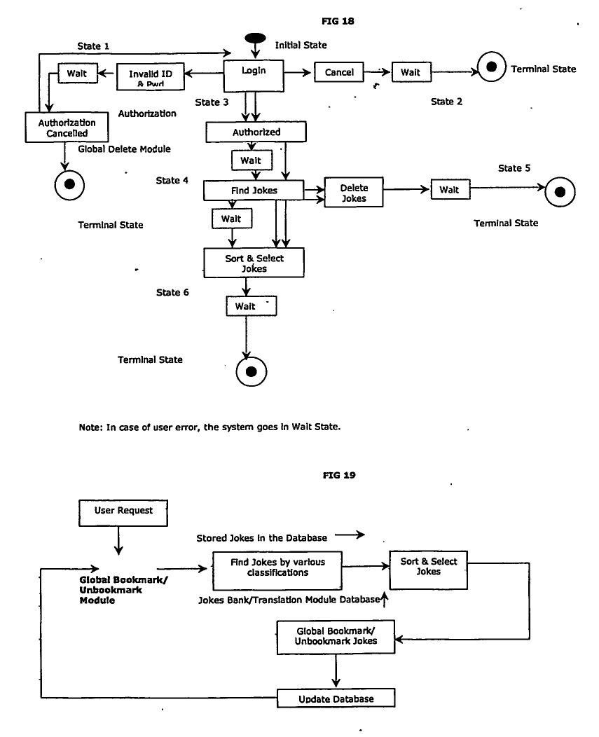

FIG. 21 describes the State Transition Diagram of the Global Bookmark/Unbookmark Module explaining that the Module is based on the different States. The system receives events from the user(s), and each event causes the transition from one state to another within the module.

Each State contains its own separate Terminal State. A double lined transition arrow from State 4 indicates that multiple instances of the state are possible. So it is possible for multiple instances of state 4 to occur, each of which has its own terminal transition. A transition showed with a dotted line indicates that it is leaving from one State and entering another state.

FIGS. 22 to 24 explain the system function, system operation and system state transition respectively of the utility of Exporting records (by means of a database file created by the system) stored in the data input module(s), by finding the same based on none or one or more FIND conditions, the Results being displayed to the User in a grid format with a further utility to Sort the Results, Ascending or Descending, by some of the relevant classifications, and further allowing the User to select the records to be Exported from the result grid. Records can also be Exported to various destinations by using the Print utility. A further utility allows the user to Export the record(s) via SMS and/or MMS and/or Email and/or Network Messaging.

FIG. 22 is the diagram of the System Function for Export Module of the present invention. The architecture of this module comprises the following major functions, which allow a user to Export Jokes by creating a database file and/or via SMS/MMS and/or Network Messaging and/or via Email with the help of the User Interface.

The Export Module through the User Interface causes the control system to find and retrieve the relevant data from Jokes Bank/Translation Module Database. The module allows a user to:
Find existing Jokes
Sort & Select Jokes
Validate Data
Export Joke(s) as Database File and/or via SMS/MMS and/or Network Messaging and/or via Email

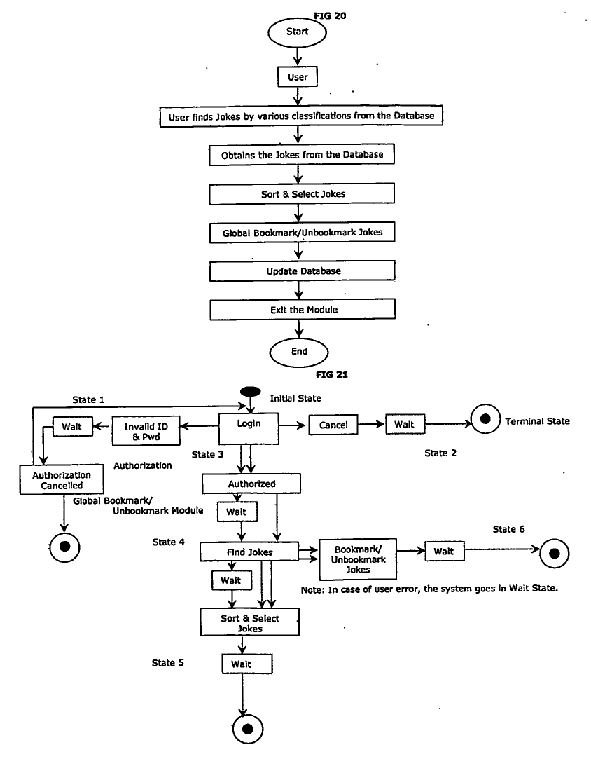

FIG. 23 describes the System Operation of Export Module explaining that the Module is based on the user actions, which are performed by loops. The Export Module allows the user to export selected Joke(s) from the database to a database file and/or via SMS/MMS and/or Network Messaging and/or via Email.

Once the user finds the Jokes the system returns to the top-level loop, and waits for the next user action. The user can sort & select the desired Jokes and then after data validation can Export Jokes as Database File and/or via SMS/MMS and/or Network Messaging and/or via Email. Then the system waits for the next user action.

On giving Close command the system gets notified and the user comes out from the module.

FIG. 24 describes the State Transition Diagram of the Export Module explaining that the Module is based on the different States. The system receives events from the user(s), and each event causes the transition from one state to another within the module.

Each State contains its own separate Terminal State. A double lined transition arrow from State 4 indicates that multiple instances of the state are possible. So it is possible for multiple instances of state 4 to occur, each of which has its own terminal transition. A transition showed with a dotted line indicates that it is leaving from one State and entering another state.

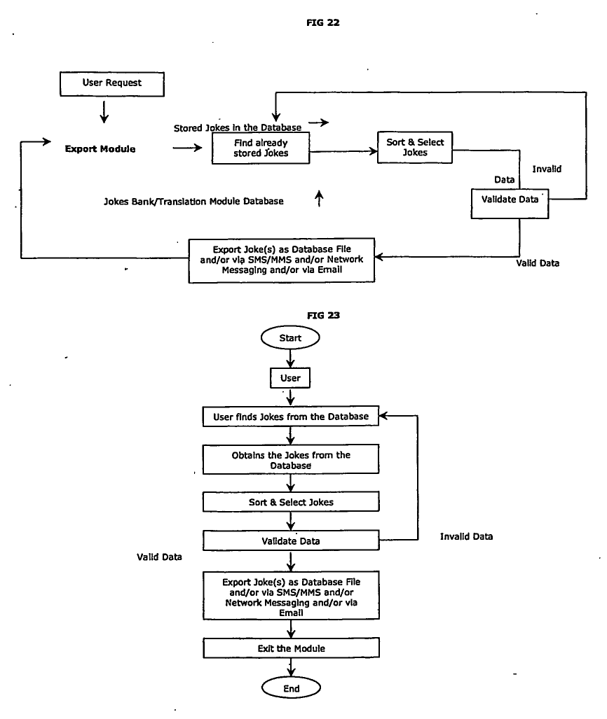

FIGS. 25 to 27 explain the system function, system operation and system state transition respectively of the utility of Importing records from a database file that may have been created by another User of this system, with the utility of appending the data already stored by the User in the data input module(s). The utility further comprises of displaying the Importable records to the User in a grid format with a further utility to Sort the data, Ascending or Descending, by the relevant classifications. The utility further allows the User to make a selection of the data to be imported; thereby allowing the User to import only such data as may be required by the Importing User.

FIG. 25 is the diagram of the System Function for Import Module of the present invention. The architecture of this module comprises the following major functions, which allow a user to Import Jokes with the help of the User Interface from a database file that may have been created by another User of this system.

The Import Module through the User Interface causes the control system to retrieve the relevant data from a valid database file. The module allows a user to:
Select File
Validate File
Get Jokes
Sort & Select Jokes
Import Jokes

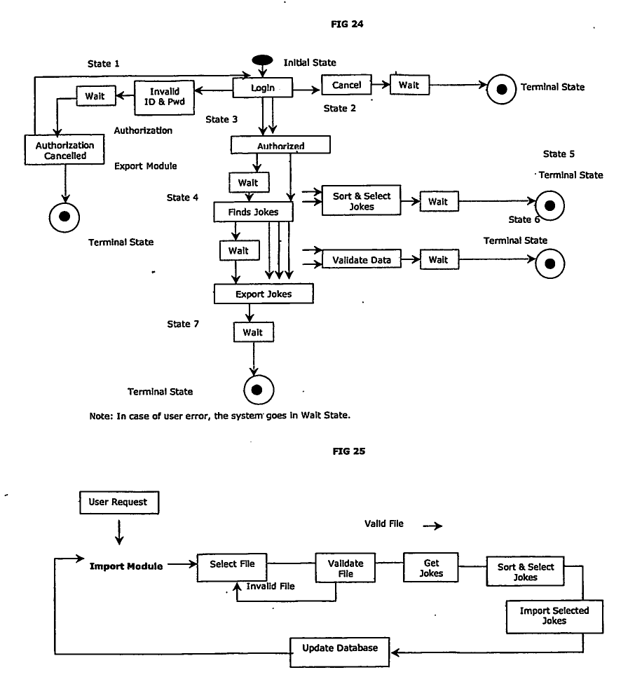

FIG. 26 describes the System Operation of Import Module explaining that the Module is based on the user actions, which are performed by loops. The Import Module allows the user to import selected Jokes from a database file that may have been created by another User of this system.

Once the user retrieves the Jokes after File Validation the system returns to the top level loop, and waits for the next user action. The user can sort & select the desired Jokes and then can Import the Jokes, selectively, if needed. Then the system waits for the next user action.

On giving Close command the system gets notified and the user comes out from the module.

FIG. 27 describes the State Transition Diagram of the Import Module explaining that the Module is based on the different States. The system receives events from the user(s), and each event causes the transition from one state to another within the module.

Each State contains its own separate Terminal State. A double lined transition arrow from State 4 indicates that multiple instances of the state are possible. So it is possible for multiple instances of state 4 to occur, each of which has its own terminal transition. A transition showed with a dotted line indicates that it is leaving from one State and entering another state.

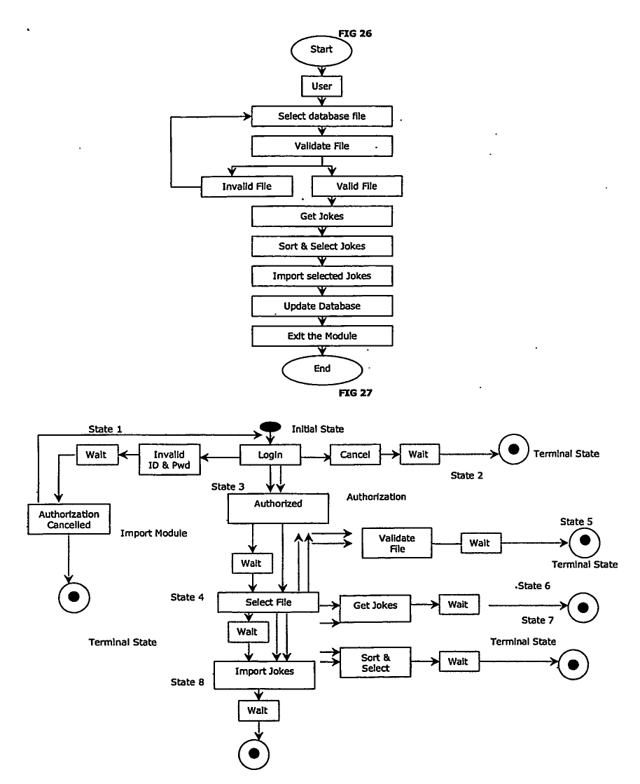

FIGS. 28 to 30 explain the system function, system operation and system state transition respectively, comprises of a Module allowing the User to invoke and store a Laughter Session, (such Laughter Sessions being capable of being taken by more than one user at the same time), using the data stored in the data input module(s), and by finding the same based on none or one or more FIND conditions, the find results being displayed to the User with a Timer, the time of display as may be selected by the User, for displaying each of the records, and the records being displayed one by one, until the number of records found by the above FIND conditions are exhausted, or until the User exits the module, as well as further allowing the User to manually navigate between the records being used in the Laughter Session, as well as further allowing the User to make a selection as to whether the User wishes to listen to the Background Music Sound File during the Laughter Session, as well as further allowing the User to make a selection as to whether the User wishes to listen to the text of the Joke or Humor, which is simultaneously displayed and spoken by a character through an embedded text to speech engine. The module further comprises of the utility of allowing the User to select the number of records that the User wishes to use for the Laughter Session, the records being randomly selected from the database, but based on the FIND conditions, and displayed to the User on the Users computer screen (including handheld devices). The module further comprises of the utility of allowing the User to repeat the Laughter session from the previously stored Laughter Session(s). The module further comprises of the utility of allowing the User to assign any previous Laughter session as the data input for the purpose of showing the data on the users screen as a screen saver. A further utility allows the user to send the record via SMS and/or MMS and/or Email and/or Network Messaging during the Laughter Session.

FIG. 28 is the diagram of the System Function for Laughter Session Module of the present invention. The architecture of this module comprises the following major functions, which allow a user to take a Laughter Session by various classifications with the help of the User Interface.

The Laughter Session through the User Interface causes the control system to find and retrieve the relevant data from the Jokes Bank Database/Translation Module Database. The module allows a user to:
Select a language
Set Find Criteria to Find Jokes
Navigate between Jokes during the Laughter Session
Activate Background Music Sound File during the Laughter Session
Activate Voice Assistant during the Laughter Session
Send Joke as SMS/MMS and/or Network Messaging and/or via Email during the Laughter Session

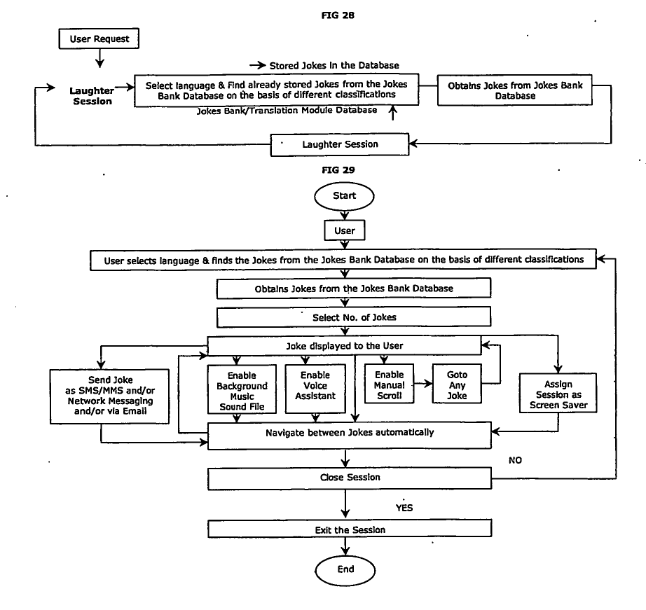

FIG. 29 describes the System Operation of the Laughter Session Module explaining that the Module is based on user actions, which are performed by loops. It allows user to invoke a Laughter Session by well-defined classifications with the help of the User Interface. Such invoked Laughter Sessions are stored by the system for further use.

The user selects the language, No. of Jokes and then finds the Jokes from the Database. The system then waits for the next user action. The user can also listen to the Background Music Sound File or can activate the Voice Assistant during the Laughter Session. The system then waits for the next user action. The user can also navigate between the Jokes and can also jump to any Joke at any point of time during the Session, and after this the user can notify the system that the session is finished. The user can also send the Joke as SMS/MMS and/or Network Messaging and/or via Email. The system then waits for the next user action.

On giving Close command the system gets notified and the user comes out from the module.

FIG. 30 describes the State Transition Diagram of the Laughter Session Module explaining that the Module is based on the different States. The system receives events from the user(s), and each event causes the transition from one state to another within the module.

Each State contains its own separate Terminal State. A double lined transition arrow from State 4 indicates that multiple instances of the state are possible. So it is possible for multiple instances of state 4 to occur, each of which has its own terminal transition. A transition showed with a dotted line indicates that it is leaving from one State and entering another state.

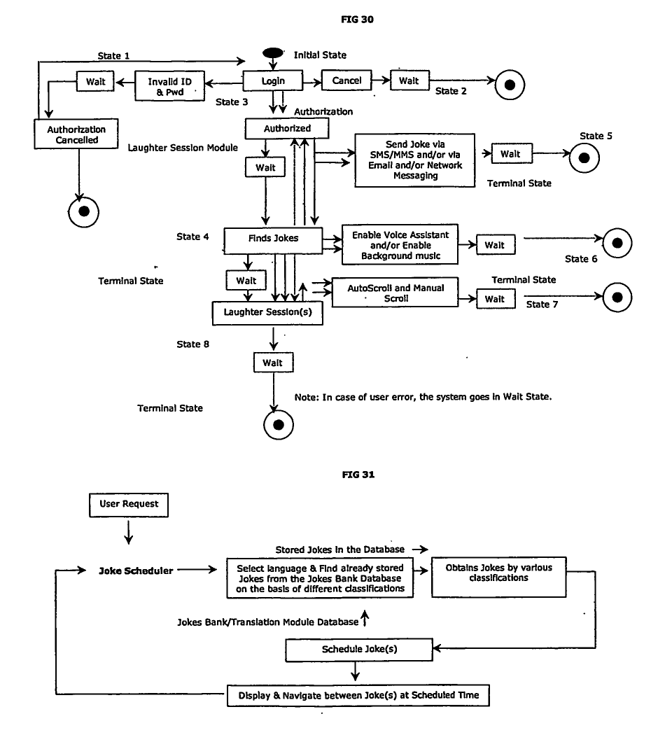

FIGS. 31 to 33 explain the system function, system operation and system state transition respectively, comprises of the utility of a well classified module capable of allowing the User to Schedule the Jokes and/or such Humor by finding the same based on none or one or more FIND conditions, and to be brought up on the User's computer screen including hand held devices at preset timed intervals, with or without Voice, in the case of with voice, the text of such Jokes and/or Humor being additionally displayed on the User's computer screen including hand held devices and simultaneously being spoken by a character, through an embedded text to speech engine and further that the User has the ability to selectively Schedule the Jokes and/or such Humor. A further utility allows the user to send the record via SMS and/or MMS and/or Email and/or Network Messaging at any time before the Scheduling Session is over.

FIG. 31 is the diagram of the System Function for Joke Scheduler Module of the present invention. The architecture of this module comprises the following major functions, which allow a user to find the Jokes by various classifications and schedule them as desired with the help of the User Interface.

The Joke Scheduler through the User Interface causes the control system to find and retrieve the relevant data from the Jokes Bank Database/Translation Module Database. The module allows a user to:
Select a language
Find existing Jokes
Sort & Select Jokes
Schedule time interval between the selected Jokes
Activate Background Music Sound File
Activate Voice Assistant
Send Joke as SMS/MMS and/or Network Messaging and/or via Email when the Joke is displayed

NOTE: The Scheduler remains active in the system tray irrespective of whether the software is running or not.

FIG. 32 describes the System Operation of the Joke Scheduler Module explaining that the Module is based on user actions, which are performed by loops. It allows user to schedule Jokes at predefined intervals, which may be selected by well-defined classifications with the help of the User Interface.

The user selects the language, No. of Jokes and then finds the Jokes from the Database. The system then waits for the next user action. The user can also select to listen to the Background Music Sound File or can select to activate the Voice Assistant during the scheduling activity and after this the user can notify the system that the session is finished. The system then waits for the next user action. The scheduled Jokes get displayed according to the specified time. The user can also send the Joke as SMS/MMS and/or Network Messaging and/or via Email. The system then waits for the next user action.

On giving Close command the system gets notified and the user comes out from the module.

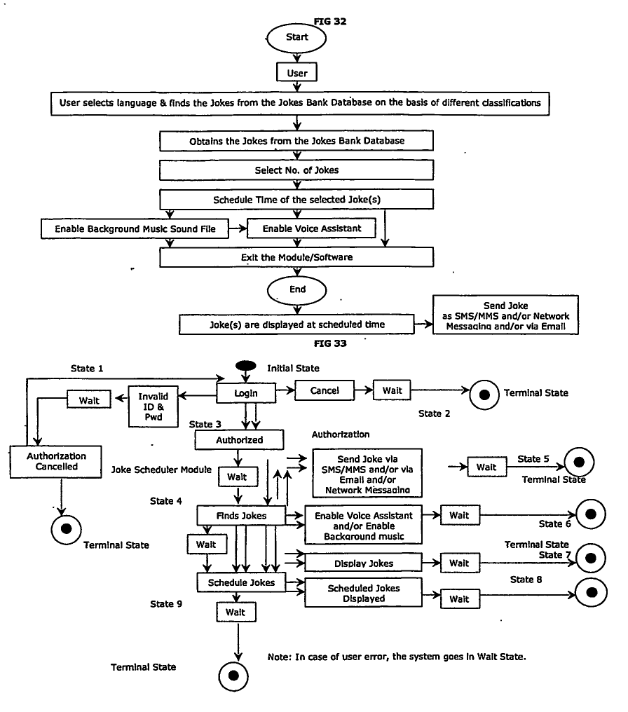

FIG. 33 describes the State Transition Diagram of the Joke Scheduler Module explaining that the Module is based on the different States. The system receives events from the user(s), and each event causes the transition from one state to another within the module.

Each State contains its own separate Terminal State. A double lined transition arrow from State 4 indicates that multiple instances of the state are possible. So it is possible for multiple instances of state 4 to occur, is each of which has its own terminal transition. A transition showed with a dotted line indicates that it is leaving from one State and entering another state.

FIGS. 34 to 36 explain the system function, system operation and system state transition respectively, comprises of the utility of Restoring or Permanently Deleting a record, which may have been deleted by the User from the data input module(s), and having the further utility of selectively Restoring or Permanently deleting a record or a group of records, the records being displayed to the User in the Recycle Bin module in a grid format with a further utility to Sort the Results, Ascending or Descending, by some of the relevant classifications, and further allowing the User to select the records to be selectively Deleted or Restored from the result grid. Any record Restored is sent back to the data input module(s), with its original ID Number.

FIG. 34 is the diagram of the System Function for Recycle Bin Module of the present invention. The architecture of this module comprises the following major functions, which allow a user to restore/permanently delete Jokes with the help of the User Interface.

The Recycle Bin Module through the User Interface causes the control system to display the deleted data of Jokes Bank/Translation Module Database. The module allows a user to:
Sort & Select Joke(s)
Restore/Permanently Delete Joke(s)

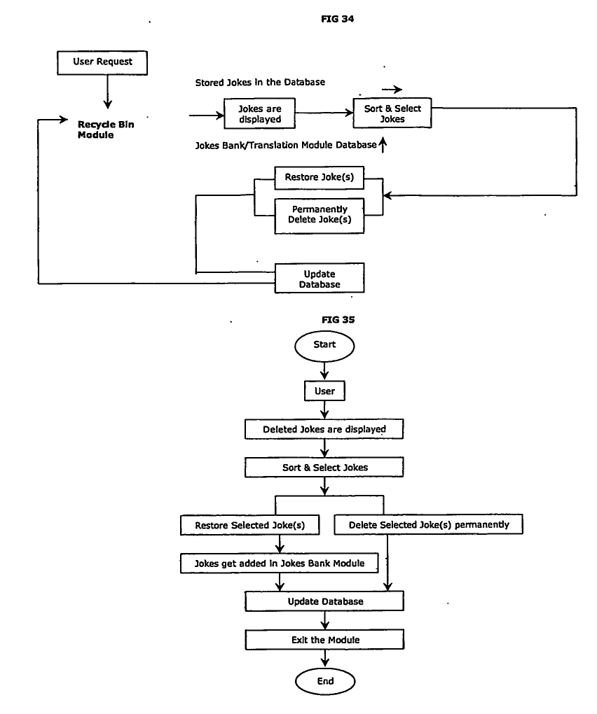

FIG. 35 describes Recycle Bin Module explaining that the Module is based on the user actions. This module allows the user to restore/permanently delete Jokes with the help of the User Interface.

The selection of Recycle Bin Module allows all the Jokes to get displayed by User Interface that may have been deleted earlier and still lying in the Recycle Bin. The user can sort & select these displayed Jokes. The system then waits for the next user action. The user is allowed to either to delete permanently or restore the selected Jokes through the User Interface. The system then waits for the next user action.

On giving Close command the system gets notified and the user comes out from the module.

FIG. 36 describes the State Transition Diagram of the Recycle Bin Module explaining that the Module is based on the different States. The system receives events from the user(s), and each event causes the transition from one state to another within the module.

Each State contains its own separate Terminal State. A double lined transition arrow from State 4 indicates that multiple instances of the state are possible. So it is possible for multiple instances of state 4 to occur, each of which has its own terminal transition. A transition showed with a dotted line indicates that it is leaving from one State and entering another state.

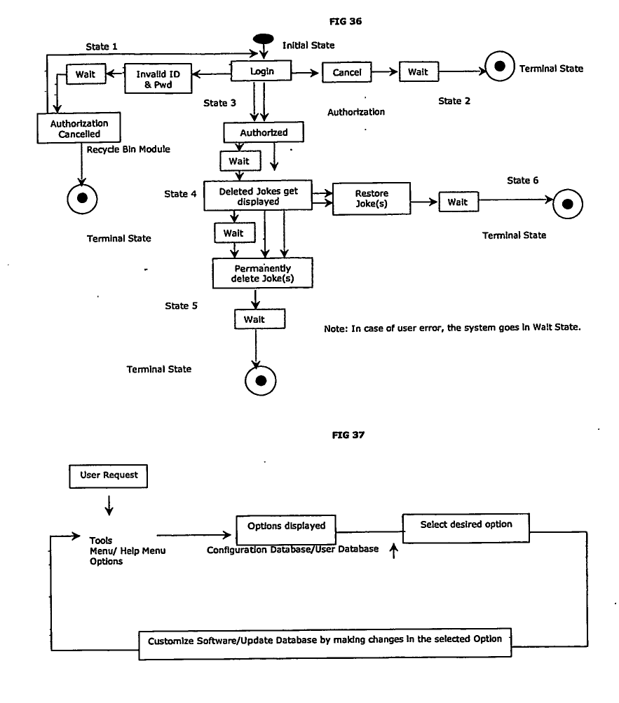

FIGS. 37 to 39 explain the system function, system operation and system state transition respectively, comprises of software maintenance Tools such as Back Up, Restore, and Compression of the entire database and System Check. There are other tools such as Start Up options, Data Entry Options, Change Sound, Customize Header and Footer, Graphical User Interface Manager, Labels, Select Skin, Remove Laughter Session(s) and Help. The System allows the creation of Sub Users who are able to set their own preferences with respect to the relevant tools.

The system wherein one or more module(s)/utility or program of the same can Operate within a browser and/or other viewing and/or processing programs, and can operate on one or more computer systems including hand held devices.

FIG. 37 is the diagram of the System Function for Tools/Help Menu Options of the present invention. The architecture of these options comprises the following major functions, which allow a user to select any option for Customization including software maintenance and updating of database.

The Tools/Help Menu Options through the User Interface retrieves and brings forth the following options:
Back Up
Restore & Compression of the entire database
System Check
Start Up options
Data Entry Options
Change Sound
Select Skin
Graphical User Interface Manager
Customize Header & Footer
Label Printing
Remove Laughter Session(s)
Help

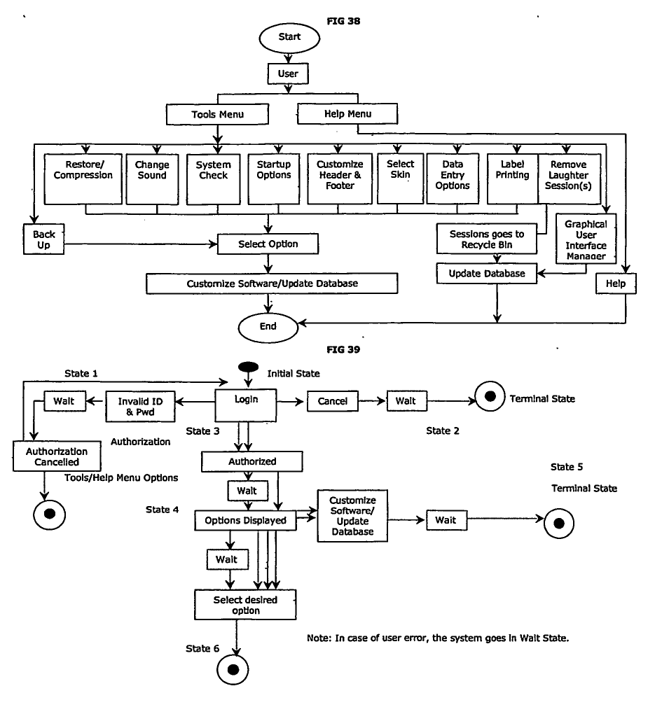

FIG. 38 describes the options of the Tools Menu options and Help Menu options explaining that the Module is based on the user actions. Through these options, the user can select any option for customization, including software maintenance and update of database. The User has the following options for customization:
Back Up—This utility allows the User to back up the entire Database
Restore/Compress—This utility allows the User to restore/compress the entire Database
Change Sound—This utility allows the User to change the background and laughter sounds
System Check—This utility allows the User to initiate a System check
Start Up Options—This utility allows the User to set conditions like Login Screen and Quick Start Screen to appear each time the system is initiated
Data Entry Options—This utility allows the User to copy an existing classification and previously entered data for new data input.
Label Printing—This utility allows the User to print the existing labels.
Customize Header and Footer—This utility allows the User to customize the Header and Footer for the Printed outputs.
Customize Graphical User Interface—This utility allows the User to change the Labels that appear on the Graphical User Interface.
Select Skin—This utility allows the User to select the “skins” for the Graphical User Interface.
Remove Laughter Session(s)—This utility allows the User to delete earlier Laughter Sessions, such deletions being capable of being made selectively.
Help—This utility allows the User to invoke the Help files, which provide the Help on how best to use the System.

FIG. 39 describes the State Transition Diagram of the Tools/Help Menu Options explaining that the Module is based on the different States. The system receives events from the user(s), and each event causes the transition from one state to another within the module.

Each State contains its own separate Terminal State. A double lined transition arrow from State 4 indicates that multiple instances of the state are possible. So it is possible for multiple instances of state 4 to occur, each of which has its own terminal transition. A transition showed with a dotted line indicates that it is leaving from one State and entering another state.

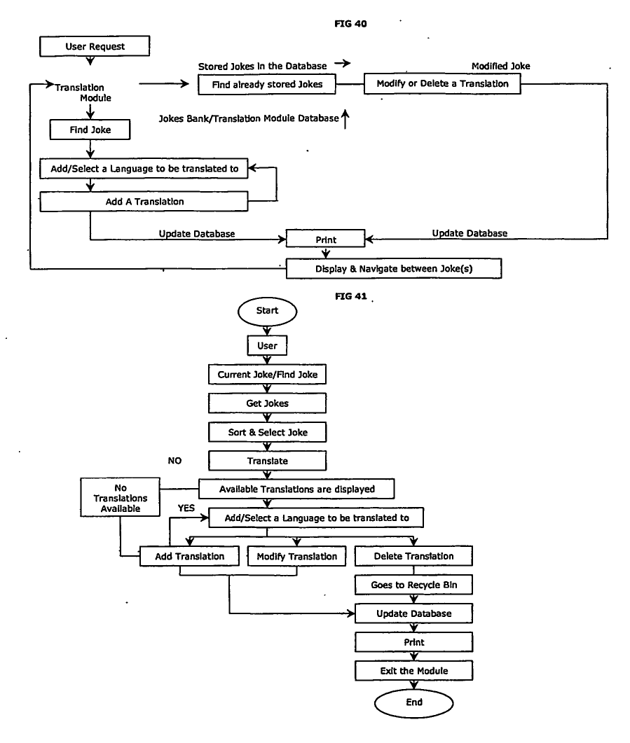

FIGS. 40 to 45 explain the system function, system operation and system state transition respectively, comprises of a Translation utility, allowing the User to consider any record as a parent language record and translate the same in any language of the User's choice, the translation activity happening from a translation module which is invoked in the input module(s), and further that all of the features and/or utilities/functionality of the system remaining common to the translated record as would be applicable to the parent language record. There is a further utility of “Global Translation” where, Record(s) can be found and part(s) of the record(s) can be translated Globally. The records can be translated Globally by finding them based on none or one or more FIND conditions, the Results being displayed to the User in a grid format with a further utility to Sort the Results, Ascending or Descending, by some of the relevant classifications, and further allowing the User to select the records to be Globally translated from the result grid.—EXAMPLE—The User may want to translate the Subject of some or all Jokes having been classified under MEDICAL PROFESSION from English to Spanish. The Global utility would permit the User to translate this across multiple records instead of translating the same one by one.

FIG. 40 is the diagram of the System Function for Translation Module of the present invention. The architecture of this module comprises the following major functions, which allow a user to consider any Joke as a parent language Joke and translate the same in any language of the User's choice.

The Translation Module through the User Interface causes the control system to find and retrieve the relevant data from the Jokes Bank/Translation Module Database. The module allows a user to:
Find existing Jokes
Sort & Select Jokes
Select/Add a language
Add Translations
Modify Translations
Delete Translations
Print

FIG. 41 describes the System Operation of Translation Module explaining that the Module is based on the user actions, which are performed by loops. The Translation Module allows the user to consider any Joke as a parent language Joke and translate the same in any language of the user's choice.

The user finds the jokes by various classifications. The user then sorts & selects those found Jokes and then the system waits for the next user action. Then the user selects a Joke to be translated and translates the same field by field through the User Interface. The user can also modify an earlier translation or delete the same. The system then waits for the next user action. The user is able to Print the record from this module after selecting the appropriate print criterion. The system waits for the next user action.

On giving Close command the system gets notified and the user comes out from the module.

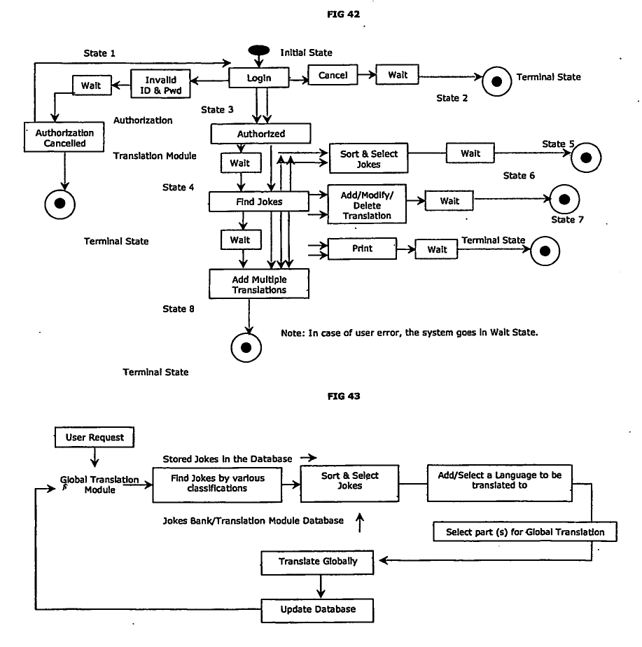

FIG. 42 describes the State Transition Diagram of the Translation Module explaining that the Module is based on the different States. The system receives events from the user(s), and each event causes the transition from one state to another within the module.

Each State contains its own separate Terminal State. A double lined transition arrow from State 4 indicates that multiple instances of the state are possible. So it is possible for multiple instances of state 4 to occur, each of which has its own terminal transition. A transition showed with a dotted line indicates that it is leaving from one State and entering another state.

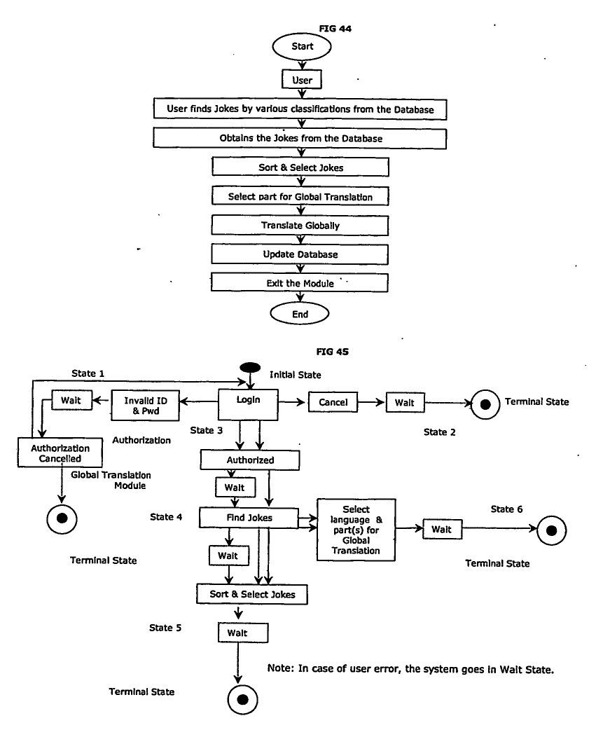

FIG. 43 is the diagram of the System Function for Global Translation Module of the present invention. The architecture of this module comprises the following major functions, which allow a user to translate a selected part of the parent language Joke across several Jokes Globally in any language of the User's choice.

The Global Translation Module through the User Interface causes the control system to find and retrieve the relevant data from the Jokes Bank/Translation Module Database. The module allows a user to:
Find existing Jokes
Sort & Select Jokes
Select/Add a language
Select part for Global Translation
Translate Globally

FIG. 44 describes the System Operation of Global Translation Module explaining that the Module is based on the user actions. Through this Translation Module, the user can translate a part of a Joke across multiple Jokes Globally.

Once the user finds the Jokes by various classifications the user can sort & select those found Jokes and then the system waits for the next user action. Then the user can select part of the found Jokes and translate the same across the found Jokes through the User Interface. The system waits for the next user action.

On giving Close command the system gets notified and the user comes out from the module.

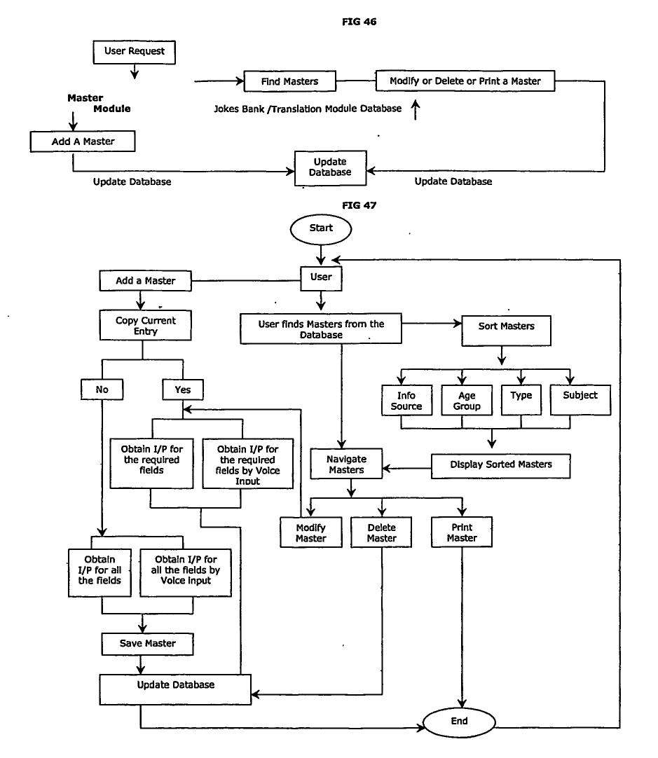

FIG. 45 describes the State Transition Diagram of the Global Translation Module explaining that the Module is based on the different States. The system receives events from the user(s), and each event causes the transition from one state to another within the module.

Each State contains its own separate Terminal State. A double lined transition arrow from State 4 indicates that multiple instances of the state are possible. So it is possible for multiple instances of state 4 to occur, each of which has its own terminal transition. A transition showed with a dotted line indicates that it is leaving from one State and entering another state.

FIGS. 46 to 48 explain the system function, system operation and system state transition respectively, of at least one well classified Master module which accept data (such Data capable of being accepted from more than one user at the same time), with or without Voice, from the User. The System provides the utility of creating, editing, deleting, printing, navigating, finding Masters like; User, Age Group, Info Source, Type, Subject, Language etc. Sufficient security is provided by the System, so as not to allow the deletion of any Master of a record that may be in use.

FIG. 46 is the diagram of the System Function for Master Module of the present invention. The architecture of this module comprises the following major functions, which allow a user to create and store Masters by well-defined classifications with the help of the User Interface.

The Master Module through the User Interface causes the control system to retrieve the relevant data from the Jokes Bank Database/Translation Module Database. The module allows a user to:
Find existing Master(s)
Sort & Select Master(s)
Add & Save Master(s)
Modify & Save Master(s)
Delete Master(s)
Copy Current Entry
Print Master(s)
Go To a Master

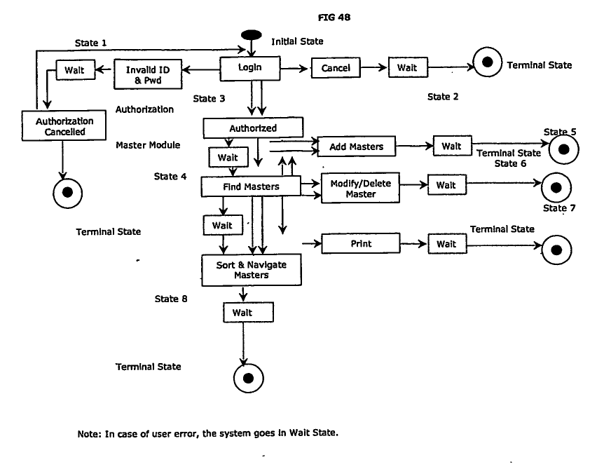

FIG. 47 describes the System Operation of the Master Module explaining that the Module is based on user actions, which are performed by loops. It allows User to create and store Masters by well-defined classifications with the help of the User Interface.

The Add functionality allows the user to Input data in all the fields. The functionality is controlled through a top-level loop. The control system updates the Database and then the system waits for the next user action.

The Find functionality is controlled through a top-level loop wherein the user is asked to enter/select the find criteria, to bring forth Masters based on the find criteria. After finding the Masters, the user can sort the Masters by different classifications and then can modify, delete or print the Masters. After modification, if the user saves the Master, the database gets updated and then the system waits for the next user action. Similarly, after deleting a Master, the database gets updated and then the system waits for the next user action.

The Copy Current Entry functionality is controlled through a top-level loop. This functionality allows the user to copy the data existing in one or more of the current Master and make the necessary additions/modifications in the other fields. The control system updates the new Master in the Database and then the system waits for the next user action.

The Printing functionality is controlled through a top-level loop. The user can print the Masters. The control system retrieves the Master(s) from the Database and then the system waits for the next user action.

The Navigation functionality allows the user to navigate between Masters.

On giving Close command the system gets notified and the user comes out from the module.

FIG. 48 describes the State Transition Diagram of the Master Module explaining that the Module is based on the different States. The system receives events from the user(s), and each event causes the transition from one state to another within the module.

Each State contains its own separate Terminal State. A double lined transition arrow from State 4 indicates that multiple instances of the state are possible. So it is possible for multiple instances of state 4 to occur, each of which has its own terminal transition. A transition showed with a dotted line indicates that it is leaving from one State and entering another state.

Thus, while there have been shown and described and pointed out fundamental novel features of the present invention as applied to preferred embodiments thereof, it will be understood that the described embodiments are to be considered in all respects only as illustrative and not restrictive and various omissions, substitutions and changes in the form and details of the methods described may be made by those skilled in the art without departing from the spirit of the present invention. For example, it is expressly intended that all combinations of those elements and/or method steps which perform substantially the same function in substantially the same way to achieve the same results are within the scope of the invention. Substitutions of elements from one described embodiment to another are also fully intended and contemplated. It is the intention, therefore, to be limited only as indicated by the scope of the claims appended hereto. All changes which come within the meaning and range of equivalency of the claims are to be embraced within their scope.

1-15. (canceled)

16. A system for building and sharing a databank of jokes and/or such humor, in one or more languages, using a computer system, comprising:
(a) a User Interface;
(b) one or more well-classified databases to store data user wise including a User Database;
(c) at least one well classified data input organizing and management module;
(d) modules for sharing, invoking, storing, and/or improving one's knowledge on jokes and/or such humor using the data from the databank, said data having been selected by a user by finding the same by none or one or more “FIND” conditions; and
(e) a control system acting as a bridge between the User Interface and the databases.

17. The system according to claim 16 wherein the modules include a Laughter Session Module for invoking and storing a laughter session for continuous entertainment/enjoyment using the data from the databank, such data having been selected by the user by finding the same by none or one or more “FIND” conditions.

18. The system according to claim 16 wherein the modules include a Joke Scheduler Module for allowing one or more users to schedule the jokes and/or such humor by finding the same from the databank by none or one or more “FIND” conditions, and said jokes or humor are brought up on the user's computer system at preset time intervals.

19. The system according to claim 16 wherein the modules include an Export Module for allowing one or more users to export data from the databank, such data having been selected by the user by finding the same by none or one or more “FIND” conditions.

20. The system according to claim 16 wherein the modules include an Import Module for allowing one or more users to import data built by other users.

21. The system according to claim 20 wherein the Import Module further includes a utility for selectively importing the data.

22. The system according to claim 16 wherein said data input organizing and management module allows the user to classify the data by well-defined classifications like Date of Entry, Source of Information, Type of Record, Age Group, Difficulty Level, Subject and Sub-Subjects.

23. The system according to claim 16 wherein the modules include a Global Attachment Module for allowing the user to attach image, animation, or sound files to a plurality of records individually and globally.

24. The system according to claim 16 wherein the modules include a Global Association Module for allowing one or more users to associate files, URLs, and/or remarks, to a plurality of records individually and globally.

25. The system according to claim 16 wherein said data input organizing and management module further includes a utility for copying of existing classification and previously entered data for new data input by the user for ease of data entry.

26. The system according to claim 16 wherein the modules include a Global Modification Module for allowing the user to modify a record individually and globally.

27. The system according to claim 16 wherein the modules include a Global Delete Module for allowing the user to delete a record individually and globally.

28. The system according to claim 16 wherein the modules include a Recycle Bin Module for allowing the user to restore or permanently remove a record individually and plurally from the system.

29. The system according to claim 16 wherein the “FIND” conditions are defined by classifications, as well as by keywords, file attachments or bookmark remarks.

30. The system according to claim 16 wherein the modules include a Global Bookmarkt/Unbookmark Module for allowing the user to bookmark or unbookmark a plurality of records individually and globally with bookmark remarks including “Private” or “Public”.

31. The system according to claim 16 wherein the modules include a Translation Module as well as a Global Translation Module for allowing translation of a record from one language into another of user's choice individually or globally.

32. The system according to claim 16 wherein the modules include a Tools/Help Menu Options Module for allowing the user to select an option for customization including system maintenance and updating of a database.

33. The system according to claim 16 wherein the modules include a Master Module for allowing the user to create and store masters for well defined classifications.

34. The system according to according to claim 16 wherein the modules and utilities are adapted to be operated within a browser and/or other viewing and/or processing programs and to operate on one or more computer systems including hand held devices.
